(19) United States
(12) Patent Application Publication
(10) Pub. No.: US 2018/0073638 A1
(43) Pub. Date: Mar. 15, 2018

(54) ROTARY MACHINE

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventors: Satoshi Saburi, Tokyo (JP); Shinichiro Tokuyama, Hiroshima-shi (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/560,346

(22) PCT Filed: Oct. 9, 2015
(86) PCT No.: PCT/JP2015/078796

§ 371 Date: Sep. 21, 2017

(30) Foreign Application Priority Data
Mar. 24, 2015 (JP) 2015-060612

(51) Int. Cl. F16J 15/40; F04D 29/42; F04D 29/44; F04D 29/16

(52) U.S. Cl. CPC F16J 15/40; F04D 29/161; F04D 29/44; F04D 29/4226

(57) ABSTRACT

A rotary machine includes a rotor, a casing, a seal portion, and a high pressure fluid supply portion. The rotor includes a rotary shaft that rotates around an axial line and an impeller that rotates with the rotary shaft to compress a fluid; the casing defines a casing flow path through which the fluid compressed by the impeller flows and covers the rotor from an outer peripheral side; the seal portion includes an opposing surface opposite the outer peripheral surface of the rotor in the gap and seals the fluid that flows through the gap in a direction of the axial line from a high pressure side toward a low pressure side; and the high-pressure fluid supply portion supplies the fluid on the high pressure side flowing through the casing flow path to the gap.

### TECHNICAL FIELD

The present invention relates to a rotary machine.

Priority is claimed on Japanese Patent Application No. 2015-060612, filed on Mar. 24, 2015, the content of which is incorporated herein by reference.

### BACKGROUND ART

In general, in a rotary machine such as a centrifugal compressor, there is a gap between a rotating body such as a rotary shaft and a stationary body such as a casing around the rotating body. Accordingly, in most cases, a seal for preventing a working fluid from flowing into the gap between the rotating body and the stationary body is provided. In a centrifugal compressor, the seal is provided in a mouthpiece portion of an inlet of an impeller, a portion between stages of a multi-stage impeller, a balance piston portion provided at a final stage of a multi-stage impeller, or the like. For example, for various seals, a damper seal or a labyrinth seal is used.

In a labyrinth seal, a plurality of protrusions which protrude from an annular stationary side member facing a rotating rotary shaft with a gap toward the rotary shaft are disposed. In the labyrinth seal, a pressure loss is generated in a fluid flowing through the vicinity of the tip of the protrusion, and thus, it is possible to decrease leakage of the fluid. As the damper seal, a honeycomb seal, a hole pattern seal, or the like is known. For example, in the hole pattern seal, a plurality of hole portions is formed on an opposing surface which opposites the rotary shaft in the annular stationary side member which is disposed with a gap between the rotary shaft and the stationary side member. In the hole pattern seal, it is possible to decrease leakage of the fluid by a pressure loss generated in the hole portions.

Compared to the labyrinth seal, the damper seal is superior in that damping effects are larger and stabilization of vibrations of the rotary shaft is realized. Meanwhile, compared to the damper seal, in the labyrinth seal, a leakage amount of a fluid can be decreased.

The rotary shaft of a rotary machine is supported by a bearing. If a destabilizing force generated by the above-described seal or impeller increases with respect to a damping force obtained by the bearing, unstable vibrations occur at a natural frequency of the rotary machine determined by a load, a rotation speed, or the like. As a result, the rotary shaft shakingly rotates. The shaking rotation vibrations can be decreased by damping effects of the above-described damper seal or labyrinth seal. However, it is known that the damping effects of the seal are decreased by a swirling flow which is generated by a portion of a compressed fluid in the rotary machine flowing into a gap between the seal and the rotary shaft while swirling.

Accordingly, for example, PTL 1 discloses a centrifugal compressor in which a shunt hole for a swirl canceller is provided in a labyrinth seal of a balance piston portion. In the centrifugal compressor disclosed in PTL 1, one end of the shunt hole communicates with a scroll and the other end thereof communicates with the labyrinth seal. According to this configuration, a high pressure fluid flowing through the scroll is introduced from the shunt hole, and the swirling flow flowing into the labyrinth seal is alleviated to decrease unstable vibrations.

### CITATION LIST

### Patent Literature

[PTL 1] Japanese Unexamined Patent Application, First Publication No. 2012-072775

However, in the centrifugal compressor disclosed in PTL 1, a force for weakening the swirling flow using the high pressure fluid introduced from the shunt hole gradually loses toward a downstream of the swirling flow, and thus, the speed of the swirling flow increases. Accordingly, there is a possibility that the swirling flow flowing into the seal portion cannot be sufficiently decreased in the downstream region away from the shunt hole.

### SUMMARY OF INVENTION

One or more embodiments of the present invention provide a rotary machine capable of extensively decreasing a swirling flow flowing into a seal portion.

According to a first aspect of the present invention, there is provided a rotary machine, including: a rotor which includes a rotary shaft which rotates around an axial line and an impeller which rotates along with the rotary shaft to compress a fluid; a casing which defines a casing flow path through which the fluid compressed by the impeller flows, forms a gap between the casing and the rotor, and covers the rotor from an outer peripheral side; a seal portion which includes an opposing surface opposed the outer peripheral surface of the rotor in the gap and seals the fluid which flows through the gap in the direction of an axial line from a high pressure side toward a low pressure side; and a high-pressure fluid supply portion which supplies the fluid on the high pressure side flowing through the casing flow path to the gap, in which the high-pressure fluid supply portion includes a plurality of ejection ports, which are open to the opposing surface and eject the fluid to the outer peripheral surface of the rotary shaft in a direction opposite to a rotation direction of the rotary shaft, at intervals therebetween in the direction of the axial line.

According to this configuration, the fluid is ejected from the plurality of ejection ports provided at intervals in the direction of the axial line, and thus, it is possible to eject the fluid to the gap in the direction opposite to the rotation direction of the rotary shaft from a plurality of locations in the direction of the axial line. Accordingly, momentum of a swirling flow is weakened once by an inverse swirling flow generated by the fluid ejected from the ejection port on high pressure side, and thereafter, the momentum of the swirling flow on the low pressure side in the direction of the axial line can be weakened again by the inverse swirling flow generated by the fluid ejected from the ejection port on the low pressure side. Therefore, it is possible to decrease the speed of the swirling flow in the rotation direction at a plurality of locations in the direction of the axial line.

In the rotary machine of a second aspect of the present invention, in the first aspect, the ejection port may be provided on the high pressure side from a center position of a length of the opposing surface in the direction of the axial line.

According to this configuration, it is possible to weaken the momentum of the swirling flow just flowing into the space. Accordingly, it is possible to effectively decrease unstable vibrations generated in the rotary shaft by the swirling flow.

In the rotary machine of a third aspect of the present invention, in the first aspect, the high-pressure fluid supply portion may include a supply flow path which is formed in the casing to communicate with the casing flow path and a division flow path which is formed in the seal portion to connect the supply flow path and the plurality of ejection ports to each other.

According to this configuration, even when a plurality of supply flow paths corresponding to the number of the ejection ports are not formed in the casing, it is possible to eject the fluid from the plurality of ejection ports. Accordingly, it is possible to reduce the number of processing steps of the casing.

In the rotary machine of a fourth aspect of the present invention, in any one of the first to third aspects, at least one of the ejection ports is formed in a region in which a speed of the fluid in the rotation direction of the rotary shaft becomes zero.

According to this configuration, compared to a case where the fluid is ejected to a region in which the speed exceeds zero, it is possible to more effectively decrease the speed of the swirling flow.

### Advantageous Effects of Invention

According to the rotary machine of the present invention, it is possible to decrease the speed of the swirling flow in the rotation direction at a plurality of locations in the direction of the axial line, and it is possible to extensively decrease the swirling flow flowing into the seal portion.

### BRIEF DESCRIPTION OF DRAWINGS

FIG. 1 is a sectional view showing a rotary machine of one or more embodiments of the present invention.

FIG. 2 is an enlarged view of a main portion showing a seal portion and a high-pressure fluid supply portion in one or more embodiments of the present invention.

FIG. 3 is a sectional view when the high-pressure fluid supply portion of one or more embodiments of the present invention is viewed in a direction of an axial line.

FIG. 4 is an enlarged view of a main portion showing a seal portion and a high-pressure fluid supply portion in one or more embodiments of the present invention.

FIG. 5 is a schematic view showing a position of an ejection port and a magnitude of a speed of a swirling flow in a rotation direction in one or more embodiments.

FIG. 6 is a schematic view showing a position of an ejection port and a magnitude of a speed of a swirling flow in a rotation direction in a modification example of the present invention.

### DETAILED DESCRIPTION OF EMBODIMENTS

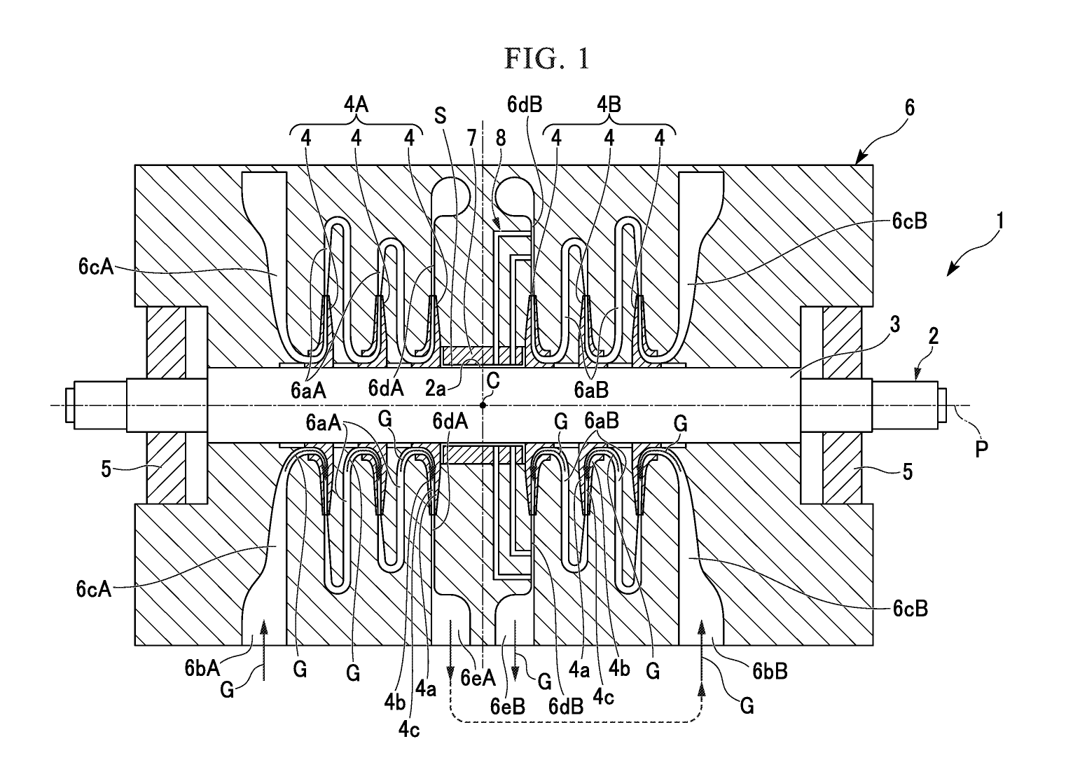

Hereinafter, a rotary machine 1 of one or more embodiments of the present invention will be described with reference to FIGS. 1 to 3.

The rotary machine 1 of the one or more embodiments includes a multistage type centrifugal compressor having a plurality of impellers 4.

The rotary machine 1 includes a rotor 2, bearings 5, a casing 6, a seal portion 7, and a high-pressure fluid supply portion 8. The rotor 2 includes a rotary shaft 3 which rotates around an axial line P and impellers 4 which rotate along with the rotary shaft 3 to compress a fluid. The bearings 5 rotatably support the rotary shaft 3 around the axial line P. The casing 6 forms a gap between the casing 6 and the rotor 2 to cover the rotor 2 from an outer peripheral side. The seal portion 7 seals the fluid which flows through the gap. The high-pressure fluid supply portion 8 supplies a compressed fluid to the gap.

The rotary shaft 3 is formed in a columnar shape about the axial line P to extend in the direction of the axial line P. The rotary shaft 3 is rotatably supported by the bearings 5 on both ends in the direction of the axial line P.

The impellers 4 are attached to the rotary shaft 3. The impellers 4 compress a process gas G (fluid) using a centrifugal force caused by a rotation. Each of the impellers 4 of one or more embodiments is a so-called closed type impeller including a disk 4a, a blade 4c, and a cover 4b.

The disk 4a is formed in a disk shape of which a diameter gradually increases to the outside in a radial direction of the axial line P toward a center position C of the rotary shaft 3 in the direction of the axial line P.

The blade 4c is formed to protrude from the disk 4a to an end portion side opposite to the center position C in the direction of the axial line P. A plurality of blades 4c are formed at predetermined intervals therebetween in a circumferential direction of the axial line P.

The cover 4b covers the plurality of blades 4c from the end portion side in the direction of the axial line P. The cover 4b is formed in a disk shape facing the disk 4a.

The bearing 5 is provided on each of both end portions of the rotary shaft 3. The bearings 5 rotatably support the rotary shaft 3. The bearings 5 are attached to the casing 6.

The plurality of impellers 4 are attached to the rotary shaft 3 between the bearings 5 disposed on both sides in the direction of the axial line P. The impellers 4 are configured of two sets of three-stage impeller group 4A and three-stage impeller group 4B in which the directions of the blades 4c face the sides opposite to each other in the direction of the axial line P. In each of the three-stage impeller group 4A and the three-stage impeller group 4B, a pressure of the process gas G on the center position C side in the direction of the axial line P is highest. That is, the process gas G flows through each of the three-stage impeller group 4A and the three-stage impeller group 4B toward the center position C in the direction of the axial line P while being compressed.

The casing 6 supports the bearings 5 and covers the rotary shaft 3, the impellers 4, and the seal portion 7 from the outer peripheral side. The casing 6 is formed in a cylindrical shape.

The casing 6 includes a suction port 6bA on one side (a first end portion side of the rotary shaft 3 and a left side on a paper surface of FIG. 1) in the direction of the axial line P. The suction port 6bA is connected to a suction flow path 6cA which is annularly formed. The suction flow path 6cA is connected to the flow path of the impeller 4 which is disposed on the most one side of the three-stage impeller group 4A. That is, the process gas G flowing in from the suction port 6bA is introduced to the three-stage impeller group 4A via the suction flow path 6cA.

The casing 6 defines a casing flow path 6aA and a casing flow path 6aB which connect the flow paths formed between the blades 4c of the impellers 4. The process gas G compressed by the impellers 4 flows through the casing flow path 6aA and the casing flow path 6aB.

The casing 6 includes a discharge port 6eA on the center position C side in the direction of the axial line P. The discharge port 6eA is connected to a discharge flow path 6dA which is annularly formed. The discharge flow path 6dA is connected to the flow path of the impeller 4 which is disposed on the most other side (a second end portion side of the rotary shaft 3 and a right side on the paper surface of FIG. 1) of the three-stage impeller group 4A. That is, the process gas G which is compressed by the impeller 4 disposed on the most other side of the three-stage impeller group 4A is discharged from the discharge port 6eA to the outside of the casing 6 via the discharge flow path 6dA.

One side and the other side of the casing 6 in the direction of the axial line P is symmetrically formed with the center position C as a boundary. The casing flow path 6aB, a suction port 6bB, a suction flow path 6cB, a discharge flow path 6dB, and a discharge port 6eB are formed on the other side of the casing 6. The three-stage impeller group 4B disposed on the other side of the casing 6 further compresses the process gas G compressed by the three-stage impeller group 4A on the one side.

That is, in the other side of the casing 6, the process gas G discharged from the discharge port 6eA is fed into the suction port 6bB. Thereafter, the process gas G flowing in from the suction port 6bB is supplied to the three-stage impeller group 4B via the suction flow path 6cB and is compressed in stages.

The process gas G compressed by the three-stage impeller group 4B is discharged from the discharge port 6eB to the outside of the casing 6 via the discharge flow path 6dB.

The process gas G compressed by the three-stage impeller group 4A as described above is introduced into the three-stage impeller group 4B to be further compressed and reaches to the vicinity of the center position C. Accordingly, a pressure difference is generated between the three-stage impeller group 4A and the three-stage impeller group 4B. Specifically, the three-stage impeller group 4A has a low pressure. The three-stage impeller group 4B has a high pressure. In the vicinity of the center position C, a gap is formed between an outer peripheral surface 31 of the rotary shaft 3 and an inner peripheral surface of the casing 6. Accordingly, the process gas G tries to flow in the direction of the axial line P through the gap toward the downstream of a low pressure side on which the three-stage impeller group 4A is disposed and which is one side in the direction of the axial line P with a high pressure side on which the three-stage impeller group 4B is disposed and which is the other side in the direction of the axial line P as the upstream.

Therefore, the seal portion 7 in one or more embodiments is provided so as to prevent the process gas G from flowing from the three-stage impeller group 4B which is the high pressure side to the three-stage impeller group 4A which is the low pressure side.

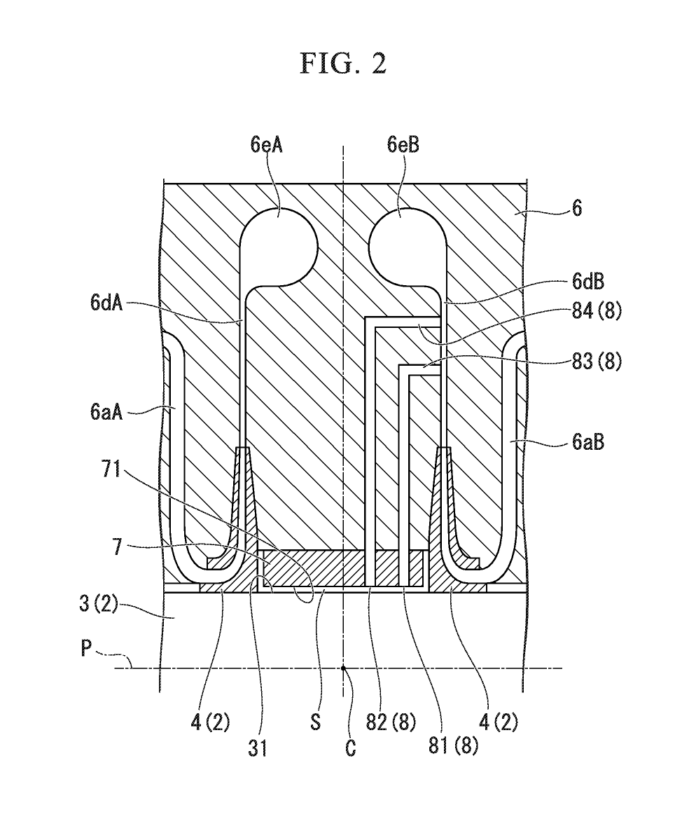

The seal portion 7 is provided in a gap which is formed between the outer peripheral surface 31 of the rotary shaft 3 and the inner peripheral surface of the casing 6 between the three-stage impeller group 4A and the three-stage impeller group 4B. The seal portion 7 seals the flows of the process gas G flowing through the gap. As shown in FIG. 2, the seal portion 7 includes an opposing surface 71 opposite the outer peripheral surface 31 of the rotary shaft 3 in the gap. The seal portion 7 is an annular member which is disposed so as to face the outer peripheral surface 31 of the rotary shaft 3. The seal portion 7 forms a predetermined space S so as to rotate the rotary shaft 3 between the seal portion 7 and the outer peripheral surface 31 of the rotary shaft 3. The seal portion 7 is positioned such that the center position C becomes the center in the direction of the axial line P. For example, in the seal portion 7 of one or more embodiments, a plurality of holes which are open to face the outer peripheral surface 31 of the rotary shaft 3 are hole pattern seals formed on the opposing surface 71.

The high-pressure fluid supply portion 8 supplies the process gas G of the high pressure side flowing through the casing flow path 6aA to the space S formed between the seal portion 7 and the rotary shaft 3 in the gap. The high-pressure fluid supply portion 8 of one or more embodiments may be a shunt hole which supplies the compressed high pressure process gas G flowing through the discharge flow path 6dB of the three-stage impeller group 4B to the space S. The high-pressure fluid supply portion 8 includes a plurality of ejection ports at positions spaced by the space S in the direction of the axial line P. The ejection ports are open to the opposing surface 71 and eject the process gas G toward the outer peripheral surface 31 of the rotary shaft 3. The high-pressure fluid supply portion 8 of one or more embodiments may include first ejection ports 81 and second ejection ports 82 as the ejection ports. The first ejection ports 81 are disposed on the high pressure side in the direction of the axial line P. The second ejection ports 82 are disposed on the low pressure side in the direction of the axial line P from the first ejection ports 81.

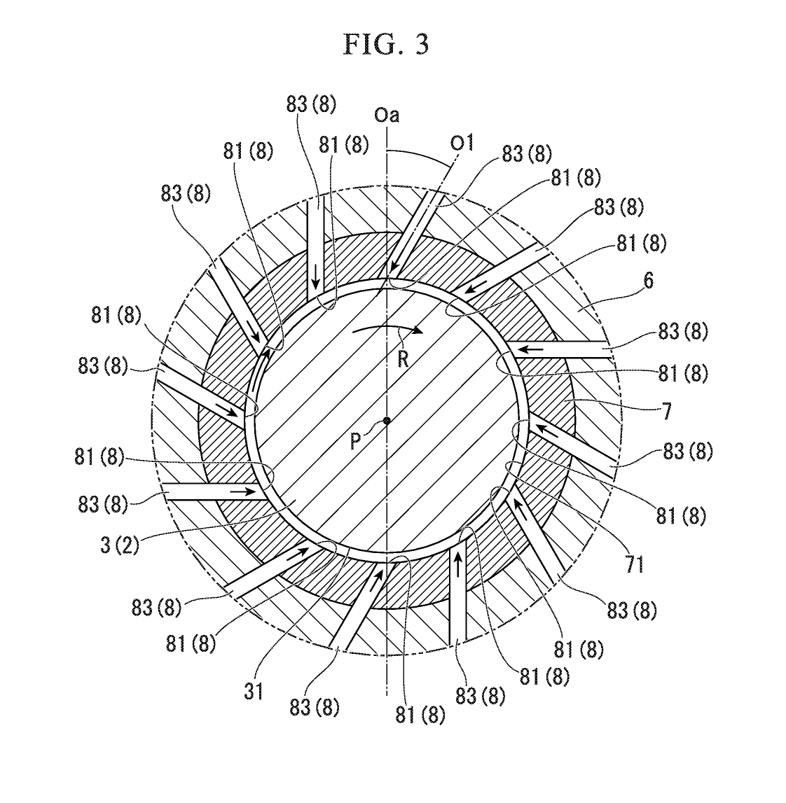

Each of the first ejection ports 81 is connected to a first supply flow path 83 formed in the casing 6 to communicate with the discharge flow path 6dB of the casing flow path 6aA. As shown in FIG. 3, a plurality of first ejection ports 81 are disposed to be separated from each other in the circumferential direction. The first ejection ports 81 eject the process gas G toward the outer peripheral surface 31 of the rotary shaft 3 in a direction opposite to a rotation direction R of the rotary shaft 3. Each of the first ejection ports 81 is formed such that a direction of the central axis O 1 of the first ejection port 81 is inclined toward the front side in the rotation direction R of the rotary shaft 3 as a position is going away from the opening formed on the opposing surface 71. The rotation direction R of the rotary shaft 3 of one or more embodiments is the clockwise direction on the paper surface of FIG. 3. Specifically, each of the first ejection ports 81 is formed to be inclined such that the angle of the center axis is a predetermined angle in the circumferential direction with respect to an orthogonal axial Oa which passes through an intersection between the center axis O1 and the opposing surface 71 of the seal portion 7 and is orthogonal to the rotary shaft 3. The first ejection port 81 is provided on the end portion on the high pressure side of the seal portion 7 facing the inlet of the space S between the opposing surface 71 and the outer peripheral surface 31 of the rotary shaft 3.

Each of the second ejection ports 82 is connected to a second supply flow path 84 which is different from the first supply flow path 83 formed in the casing 6 to communicate with the discharge flow path 6dB. A plurality of second ejection ports 82 are disposed to be separated from each other in the circumferential direction. The second ejection ports 82 eject the process gas G toward the direction opposite to the rotation direction R of the rotary shaft 3. The second ejection ports 82 are formed to be inclined by angles similar to those of the first ejection ports 81. The second ejection ports 82 are provided at intervals therebetween in the direction of the axial line P with respect to the first ejection ports 81. In one or more embodiments, the second ejection ports 82 are located at a position slightly on the high pressure side from the center position C and a position on the low pressure side from the first ejection ports 81.

In the above-described rotary machine 1, the process gas G which is a fluid is compressed, and thus, a portion of the process gas G flows into the space S between the outer peripheral surface 31 of the rotary shaft 3 and the opposing surface 71 of the seal portion 7. As a result, a swirling flow is generated in a helical shape around the outer peripheral surface 31 of the rotary shaft 3 in the direction of the axial line P. The swirling flow is configured of a rotation direction flow and an axial line direction flow. The rotation direction flow is a component toward the front side in the rotation direction R of the rotary shaft 3. The axial line direction flow is a component from the high pressure side in the direction of the axial line P of the rotary shaft 3 toward the low pressure side. Accordingly, in the seal portion 7 of one or more embodiments, the process gas G generating the swirling flow flows from the high pressure side in the direction of the axial line P into the space S between the opposing surface 71 and the outer peripheral surface 31 of the rotary shaft 3. Therefore, in the seal portion 7, the process gas G is prevented from flowing from the three-stage impeller group 4B which is the high pressure side in the direction of the axial line P of the rotary shaft 3 toward the three-stage impeller group 4A which is the low pressure side.

According to the rotary machine 1 of one or more embodiments, the process gas G is ejected from the first ejection ports 81 and the second ejection ports 82 provided at intervals therebetween in the direction of the axial line P. Accordingly, it is possible to eject the fluid in the direction opposite to the rotation direction R from two locations in the direction of the axial line P to the space S between the outer peripheral surface 31 of the rotary shaft 3 and the opposing surface 71 of the seal portion 7. Specifically, in one or more embodiments, the high pressure process gas G flowing through the discharge flow path 6dB from the first ejection port 81 provided on the end portion on the high pressure side of the seal portion 7 is ejected to the space S via the first supply flow path 83. The process gas G ejected to the space S from the first ejection port 81 generates an inverse swirling flow which is directed to the rear side in the rotation direction R which is a direction opposite to the swirling flow in the rotation direction R. Accordingly, it is possible to decrease a speed in the rotation direction R of the swirling flow flowing into the space S on the high pressure side in the direction of the axial line P. Thereafter, the high pressure process gas G flowing through the discharge flow path 6dB from the second ejection port 82 provided on the low pressure side from the first ejection port 81 is ejected to the space S via the second supply flow path 84. Accordingly, the momentum of the swirling flow on the high pressure side in the direction of the axial line P is weakened once by the inverse swirling force generated by the process gas G ejected from the first ejection ports 81, and thereafter, the momentum of the swirling flow on the low pressure side in the direction of the axial line P can be weakened again by the inverse swirling flow generated by the process gas G ejected from the second ejection ports 82. That is, it is possible to decrease the speed of the swirling flow by the inverse swirling flow generated by the second ejection ports 82 provided on the low pressure side from the first ejection ports 81, in which the swirling flow is pulled by the outer peripheral surface 31 of the rotating rotary shaft 3 and the speed of the swirling flow on the front side in the rotation direction R increases as the swirling flow advances the space S in the direction of the axial line P. Accordingly, it is possible to decrease the speed of the swirling flow in the rotation direction R at two locations in the direction of the axial line P. Therefore, it is possible to extensively decrease the flowing-in swirling flow in the direction of the axial line P. As a result, it is possible to decrease unstable vibrations, which are generated in the rotary shaft 3 by the swirling flow, over a wide region in the direction of the axial line P.

The first ejection ports 81 and the second ejection ports 82 of one or more embodiments are provided on the high pressure side from the center position C. Accordingly, it is possible to weaken the momentum of the swirling flow just flowing into the space S. As a result, it is possible to effectively decrease unstable vibrations generated in the rotary shaft 3 by the swirling flow.

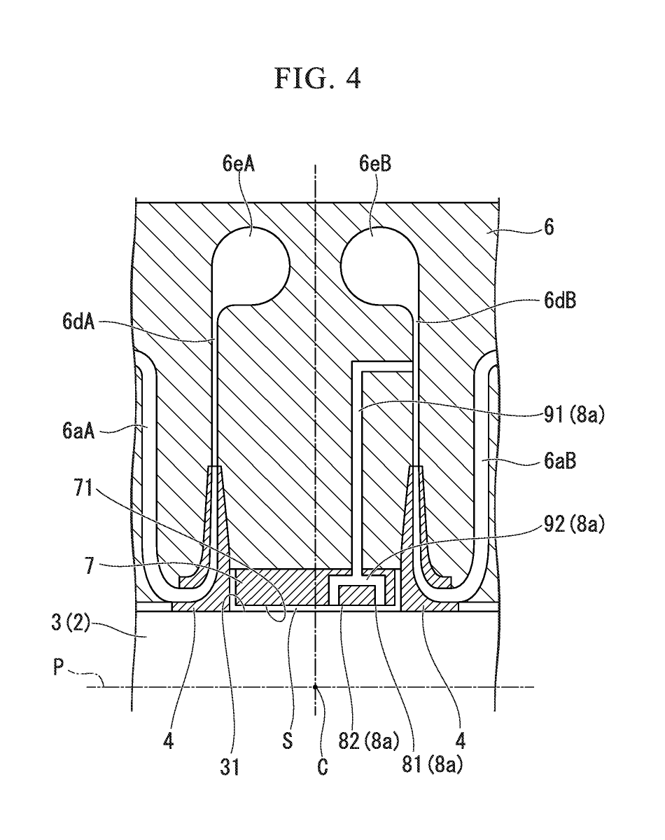

Next, a rotary machine of one or more embodiments will be described with reference to FIG. 4.

In these embodiments, the same reference numerals are assigned to the same components similar to those of the previously described embodiments, and detail descriptions thereof are omitted. A rotary machine of these embodiments is different from that of the previously described embodiments in the configuration of the high-pressure fluid supply portion.

That is, a high-pressure fluid supply portion 8a of one or more embodiments includes a common supply flow path 91 and a division flow path 92. The common supply flow path 91 is formed in the casing 6 to communicate with the discharge flow path 6dB. The division flow path 92 connects the first ejection port 81 and the second ejection port 82 similar to those of one or more embodiments and the common supply flow path 91 to each other.

The high pressure process gas G flowing through the discharge flow path 6dB via the common supply flow path 91 is supplied to the first ejection port 81 and the second ejection port 82 through the division flow path 92. The division flow path 92 is formed in the seal portion 7. The division flow path 92 extends in the direction of the axial line P. The first ejection port 81 and the second ejection port 82 are connected to each other by the division flow path 92.

According to the rotary machine 1 of one or more embodiments, the high pressure process gas G is supplied to the division flow path 92 via the common supply flow path 91 and is ejected from the first ejection port 81 and the second ejection port 82. As a result, similarly to other embodiments previously described, it is possible to decrease the speed of the swirling flow toward the front side in the rotation direction R at two locations in the direction of the axial line P. Therefore, it is possible to extensively decrease the flowing-in swirling flow in the direction of the axial line P. As a result, it is possible to decrease unstable vibrations, which are generated in the rotary shaft 3 by the swirling flow, over a wide region in the direction of the axial line P.

The first ejection port 81 and the second ejection port 82 are connected to each other by the division flow path 92 to provide the common supply flow path 91. Accordingly, even when a plurality of supply flow paths corresponding to the number of the ejection ports are not formed in the casing 6, it is possible to eject the high pressure process gas G from the first ejection port 81 and the second ejection port 82. Accordingly, it is possible to reduce the number of processing steps of the casing 6.

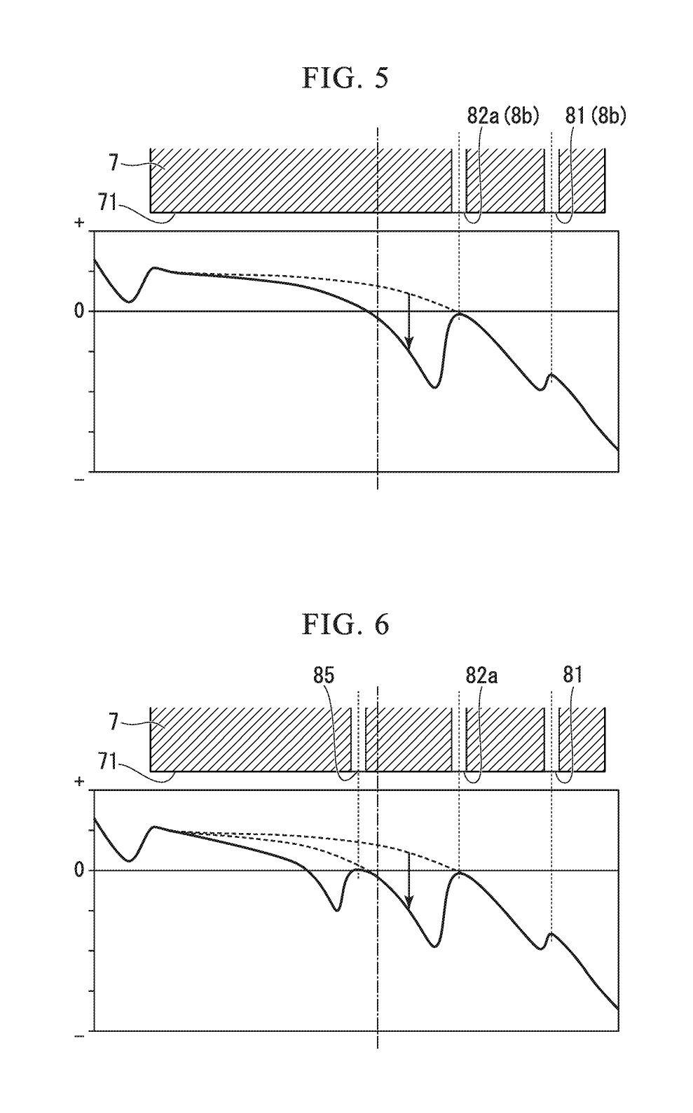

Next, a rotary machine of one or more embodiments will be described with reference to FIG. 5.

In these embodiments, the same reference numerals are assigned to the same components similar to those of the other embodiments previously described, and detail descriptions thereof are omitted. A rotary machine of the these embodiments is different from those of the other previously described embodiments in the dispositions of the ejection ports.

According to one or more embodiments, in a high-pressure fluid supply portion 8b, a second ejection port 82a is formed at a region in which the speed in the rotation direction R of the rotary shaft 3 of the swirling flow which is the process gas G flowing through the space S becomes zero.

FIG. 5 is a schematic view showing positions of the ejection ports and the magnitude of the speed of the swirling flow. In the graph of the FIG. 5, the speed of the swirling flow becomes positive in a region above zero. This indicates that the swirling flows toward the front side in the rotation direction R. On the other hand, the speed of the swirling flow becomes negative in a region below zero. This indicates that the swirling flows toward the rear side of the rotation direction R like the inverse swirling flow. As shown in FIG. 5, the second ejection port 82a of one or more embodiments is formed on the opposing surface 71 such that the opening of the second ejection port 82a is formed over the region in which the speed of the swirling flow is zero.

According to the rotary machine 1 of one or more embodiments, the process gas G is ejected from the second ejection port 82a in the region in which the speed becomes zero. As a result, compared to a case where the process gas G is ejected to a region in which the speed of the swirling flow exceeds zero and becomes positive, it is possible to eject the process gas G to treat the swirling flow in a state in which the momentum of the swirling flow is weakened. Accordingly, it is possible to effectively decrease the speed of the swirling flow. Therefore, it is possible to effectively decrease the swirling flow again on the low pressure side in the direction of the axial line P from the first ejection port 81 by the process gas G ejected from the second ejection port 82a. Accordingly, it is possible to extensively decrease the flowing-in swirling flow in the direction of the axial line P. As a result, it is possible to decrease unstable vibrations, which are generated in the rotary shaft 3 by the swirling flow, over a wide region in the direction of the axial line P.

Hereinbefore, the embodiments of the present invention are described with reference to the drawings. However, configurations and combustions of the embodiments are described as examples, and additions, omissions, replacements, and other modifications of the configurations can be applied to the present invention within a scope which does not depart from the gist of the present invention. In addition, the present invention is not limited to the embodiments and is limited by only claims.

Moreover, the above-described embodiments may be used alone or in combination. For example, in the high-pressure fluid supply portion 8b having the division flow path 92 of one or more embodiments, the second ejection port 82a may be formed in the region in which the speed of the swirling flow becomes zero. That is, the components of each embodiment may be appropriately combined by replacing them with the components of other embodiments.

The ejection port is not limited to only two ports such as the first ejection port 81 and the second ejection port 82a of the embodiments. A plurality of ejection ports may be provided at intervals therebetween in the direction of the axial line P. Therefore, three or more ejection ports may be provided. For example, in a case where three injection ports are provided, as shown in FIG. 6, the second ejection port 82a or a third ejection port 85 on the low pressure side in the direction of the axial line P from the center position C may be provided. Similarly to the second ejection port 82a of one or more embodiments, the third ejection port 85 may be formed on the opposing surface 71 such that the opening is formed over the region in which the speed of the swirling flow becomes zero. According to this configuration, it is possible to effectively decrease the speed of the swirling flow in the rotation direction R again on the lower pressure side in the direction of the axial line P from the center position C.

In the case where the third ejection port 85 is provided, the third ejection port 85 is not necessarily required to be formed in the region in which the speed of the swirling flow becomes zero, and at least one of a plurality of ejection ports may be formed in the region in which the speed of the swirling flow becomes zero.

In the above-described embodiments, the case where the seal portion 7 is provided around the rotary shaft 3 between the three-stage impeller group 4B and the three-stage impeller group 4A is described. However, the present invention is not limited to this. For example, the seal portion 7 may be provided in the high-pressure fluid supply portion 8b, the mouthpiece portion of the inlet of the impeller 4, the balance piston portion provided in the final stage of the multi-stage impeller, or the like.

The present invention is not limited to the structure in which all the ejection ports are disposed on the high pressure side from the center position C which is the center position of the length of the opposing surface 71 in the direction of the axial line P. Among the plurality of ejection ports, some ejection ports may be disposed on the low pressure side from the center position C.

The high-pressure fluid supply portion 8b is not limited to the structure of supplying the high pressure process gas G from the discharge flow path 6dB. That is, the high-pressure fluid supply portion 8b may be adopt any structure as long as it can supply the process gas G having a higher pressure than that of the process gas G flowing through the low pressure side of the seal portion 7. Accordingly, for example, the high-pressure fluid supply portion 8b may supply the process gas G from the discharge port 6eB of the three-stage impeller group 4B. For example, the high-pressure fluid supply portion 8b may supply the process gas G from the intermediate portion of the casing flow path 6aB of the three-stage impeller group 4B. For example, the high-pressure fluid supply portion 8b may supply the process gas G from the outside.

The impeller 4 is not limited to the three-stage impeller. In the above-described embodiments, for example, the centrifugal compressor is described as the rotary machine 1 including the seal portion 7. However, the rotary machine 1 is not limited to the centrifugal compressor. For example, the seal portion 7 of the present invention can be applied to an axial flow compressor, a radial flow turbine, an axial flow turbine, various industrial compressors, a turbo refrigerator, or the like.

The impeller 4 is not limited to a closed type impeller and may be an open type impeller.

### INDUSTRIAL APPLICABILITY

According to the above-described rotary machine, it is possible to decrease the speed of the swirling flow in the rotation direction at a plurality of locations in the direction of the axial line, and it is possible to extensively decrease the swirling flow flowing into the seal portion.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: rotary machine

P: axial line

C: center position

G: process gas

2: rotor

3: rotary shaft

31: outer peripheral surface

4: impeller

4A, 4B: three-stage impeller group

4a: disk

4b: cover

4c: blade

5: bearing

6: casing

6aA, 6aB: casing flow path

6bA, 6bB: suction port

6cA, 6cB: suction flow path

6dA, 6dB: discharge flow path

6eA, 6eB: discharge port

7: seal portion

71: opposing surface

S: space

8, 8a, 8b: high-pressure fluid supply portion

81: first ejection port

O1: center axis

Oa: orthogonal axis

82, 82a: second ejection port

83: first supply flow path

84: second supply flow path

R: rotation direction

91: common supply flow path

92: division flow path

85: third ejection port

1. A rotary machine, comprising:
a rotor that includes a rotary shaft that rotates around an axial line and an impeller that rotates with the rotary shaft to compress a fluid;
a casing that defines a casing flow path through which the fluid compressed by the impeller flows and covers the rotor from an outer peripheral side, wherein a gap is formed between the casing and the rotor;
a seal portion that includes an opposing surface opposite the outer peripheral surface of the rotor in the gap and seals the fluid that flows through the gap in a direction of the axial line from a high pressure side toward a low pressure side; and
a high-pressure fluid supply portion that supplies the fluid on the high pressure side flowing through the casing flow path to the gap,
wherein the high-pressure fluid supply portion includes a plurality of ejection ports that open to the opposing surface and eject the fluid to the outer peripheral surface of the rotary shaft in a direction opposite to a rotation direction of the rotary shaft, at intervals therebetween in the direction of the axial line.

2. The rotary machine according to claim 1,
wherein the ejection ports are provided on the high pressure side from a center position of a length of the opposing surface in the direction of the axial line.

3. The rotary machine according to claim 1,
wherein the high-pressure fluid supply portion includes a supply flow path which is formed in the casing to communicate with the casing flow path and a division flow path which is formed in the seal portion to connect the supply flow path and the plurality of ejection ports to each other.

4. The rotary machine according to claim 1,
wherein at least one of the ejection ports is formed in a region in which a speed of the fluid flowing through the gap in the rotation direction of the rotary shaft becomes zero.
